(19) United States
(12) Patent Application Publication
(10) Pub. No.: US 2008/0286732 A1
(43) Pub. Date: Nov. 20, 2008

(54) Method for Testing and Development of Hand Drawing Skills

(75) Inventors: Kristine Annette German, Webster, NY (US); Robert Michael Lofthus, Webster, NY (US)

Correspondence Address: PEPPER HAMILTON LLP, 500 GRANT STREET, ONE MELLON CENTER, 50TH FLOOR, PITTSBURGH, PA, 15219, US

(73) Assignee: XEROX CORPORATION, Stamford, CT (US)

(21) Appl. No.: 11/749,192

(22) Filed: May 16, 2007

(51) Int. Cl. G09B 11/00

(52) U.S. Cl. 434/162

(57) ABSTRACT

A method of performing hand drawings analysis includes storing a plurality of hand drawing exercises. Each hand drawing exercise may be configured to test an ability to draw a symbol. A record may be stored. The record may include respondent information. One or more hand drawing exercises may be selected and possibly adapted based on the responded information. A response to each selected hand drawing exercise may be received via an optical-reader device. Each response may be evaluated. The record may be updated based on the evaluated responses. Information may be provided based on the evaluated responses.

### BACKGROUND

The ability to recognize and reproduce shapes is critical to a student's development. These skills are critical for reading readiness. As students learn handwriting, they are building other developmental skills such as sequential memory and fine motor ability. These fundamental skills assist students in forming and articulating thoughts, as well as in developing other essential academic areas such as mathematics.

A person typically must be sufficiently proficient in hand drawing before he or she can write efficiently. Hand drawing includes handwriting and the ability to draw symbols. Additionally, the speed and legibility of a student's handwriting can have an impact on how a person performs throughout his or her academic career and beyond. Studies have found that poor shape reproduction and a lack of hand drawing and hand writing skills are correlated with academic risks.

Standardized tests are commonly used to test students' skills particularly since the No Child Left Behind Act of 2001 (NCBA) was passed, which designated Standardized test scores as the metric by which the student, school, county and state are measured. As such scores increase in importance, teachers will tend to teach disassociated facts and a narrow set of skills to improve test performance instead of a broad curriculum designed to provide a well-rounded education.

Restricting the subjects taught in school is particularly problematic with respect to hand drawing development skills because such skills are not typically included in standardized tests. As a result, teachers and schools are not held accountable for developing their students' hand drawing skills. Standardized tests are used to determine a student's ability to recognize shapes, but the tests do not test the ability to reproduce shapes, numbers and letters. As a result, a student may not have the necessary cognitive development and motor memory skills associated with sufficient mastery of shape reproduction.

Products designed to help with normal development of hand drawing skills or to remedy poor hand drawing skills have been developed. Internet websites offer paper workbooks that are designed to be used by parents, teachers and therapists to teach hand drawing skills to students. However, no method exists for routinely and systematically developing and testing student hand drawing skills.

As such, improved methods and systems for enabling testing of hand drawing skills, supplying adaptive hand drawing exercises, and also providing feedback regarding a user's hand drawing skills and progress would be desirable. Such methods and systems would be useful for individual student skill development as well as for benchmarking student performance across broad populations, such as at the state or school district level.

### SUMMARY

In an embodiment, a method of performing hand drawing analysis may include storing a plurality of hand drawing exercises, wherein each hand drawing exercise is configured to test an ability to draw a symbol. A record may be stored, wherein the record comprises respondent information. One or more hand drawing exercises may be selected. A response may be received, via an optical-reader device, for each selected hand drawing exercise. Each response may be evaluated. The record may be updated based on the evaluated responses. Information may be provided based on the evaluated responses.

In another embodiment, a method of hand drawing analysis may include storing a plurality of hand drawing exercises, wherein each hand drawing exercise tests an ability to draw a symbol, and wherein each hand drawing exercise comprises a skill level and a methodology. One or more hand drawing exercises may be selected. A response may be received, via an optical-reader device, to each selected hand drawing exercise. Each response may be evaluated by creating a rating. A record may be stored, wherein the record comprises respondent information and the rating. Information may be provided based on the rating.

In another embodiment, a method of performing hand drawing analysis may include storing a plurality of hand drawing exercises, wherein each hand drawing exercise is configured to test an ability to draw a symbol. A record may be stored, wherein the record comprises respondent information. One or more personalized hand drawing exercises may be selected based on the record. A response may be received for each selected hand drawing exercise. Each response may be evaluated. The record may be updated based on the evaluated responses. Information may be provided based on the evaluated responses.

In an embodiment, a system may include a storage medium containing a plurality of hand drawing exercises, wherein each hand drawing exercise is configured to test an ability to draw a symbol, and wherein each hand drawing exercise comprises a skill level and a methodology. A computing device may be in communication with the storage medium, wherein the computing device is configured to select one or more hand drawing exercises. An optical-reader device may be in communication with the computing device, wherein the optical-reader device is configured to receive a response to each selected hand drawing exercise.

### BRIEF DESCRIPTION OF THE DRAWINGS

FIG. 1 discloses a flowchart depicting an exemplary method of standardizing testing of hand drawing skills according to an embodiment.

FIG. 2 depicts an exemplary rubric for evaluating a respondent's hand drawings according to an embodiment.

FIGS. 3A-D depict exemplar hand drawing exercises according to each embodiment.

FIG. 4 depicts an exemplary system for evaluating a respondent's hand drawings according to an embodiment.

### DETAILED DESCRIPTION

Before the present methods, systems and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope. For example, as used herein and in the appended claims, the singular forms “a,” “an,” and “the” include plural references unless the context clearly dictates otherwise. In addition, the word “comprising” as used herein is intended to mean “including but not limited to.” Unless defined otherwise, all technical and scientific terms used herein have the same meanings as commonly understood by one of ordinary skill in the art.

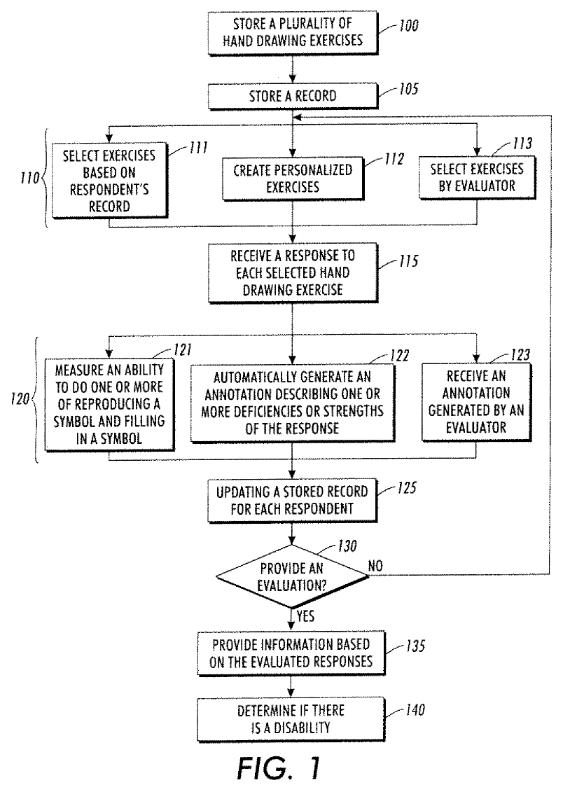

FIG. 1 discloses a flowchart depicting an exemplary method of standardizing the learning and testing of hand drawing skills according to an embodiment. As shown in FIG. 1, a plurality of hand drawing exercises may be stored 100. A hand drawing exercise is an exercise designed to teach and/or test a respondent's ability to perform a drawing task. Hand drawing includes the ability to draw symbols. A symbol refers to an external two-dimensional outline, appearance or configuration of a figure. A symbol may include, but is not limited to, a geometrical object, an alphanumeric character, a picture and/or a shape. A symbol may be characterized by basic geometry such as, but not limited to, a point, a line, a plane and/or a curve. Hand drawing may include handwriting skills.

In one embodiment, the hand drawing exercises may be stored 100 as a hierarchical organized collection of information in a processor readable storage medium. The processor readable storage medium may include, without limitation, a database, a chart, a list and/or a table containing the hand drawing exercises. In one embodiment, hand drawing exercises may include a set of exercises that exist in a non-machine readable form and may be adapted for machine reading. In another embodiment, exercises may be created on a computer readable medium. The hand drawing exercises may include glyphs and other markings for fiducial or identification purposes. A glyph is a shape given to a symbol in a particular typeface, such as a computer-readable character. A fiducial mark is a mark which may be used to locate the position of symbols to test and evaluate hand drawing skills.

In one embodiment, each hand, drawing exercise may include an assigned skill level and methodology. A skill refers to a difficulty level of an associated exercise. A methodology describes the skill that the exercise is testing. For example, methodologies may include, without limitation, tracing a dotted line, drawing one or more symbols or one or more groups of symbols, and reproducing a group of symbols within a designated space. In an embodiment, the designated space may be adjacent to the image. Alternatively, the designated space may be on a different page. Another methodology may test for an ability to fill in missing pans of a symbol. In one embodiment, a symbol with a missing part may appear in an area adjacent to the completed shape. Another methodology may test for an ability to draw a symbol from memory. Additional and/or alternate methodologies may be used within the scope of this disclosure.

A record may be stored 105 for a respondent. A respondent's record may include, but is not limited to, evaluations of the exercises and/or information pertaining to the respondent. The respondent information may include, but is not limited to, background information such as, name, age, grade and handedness (i.e., whether the respondent is left-handed or right-handed). The respondent information may also include the respondent's interests which may include categories such as, but not limited to, automobiles, buildings, flowers, plants, animals, and sports.

One or more hand drawing exercises may be selected 110 from the processor readable storage medium and provided to a respondent. Each selected exercise may be designed to measure the respondent's ability to reproduce symbols at a particular level of complexity and/or abstraction. The complexity of the hand drawing exercises may differ among exercises. In one embodiment, the one or more hand drawing exercises may be selected 110 by the system.

In one embodiment, the one or more hand drawing exercises may be selected based on a skill level stored in the record of the respondent and, or a type of methodology implemented by the exercises 111. In a further embodiment, the hand drawing exercises may be personalized based on information contained in the respondent's record 112. For example, if the record contains information that the respondent is interested in dinosaurs, then a hand drawing exercise, for example, may include a drawing of a dinosaur or test the respondent's ability to produce letters in dinosaur names depending on the skill being tested. Alternately, or additionally, the hand drawing exercises may be selected 113 by a human evaluator. In one embodiment, the evaluator may select the same exercise to be performed by a plurality of respondents. In one embodiment, selection of the exercises may be selected randomly.

After the respondent completes the exercises, the exercises may be received 115 by the system. The respondent may complete the exercise on a medium that is not computer readable. In such an embodiment, the computing device may receive 115 the completed exercise via an optical-reader device, such as a scanner.

After the completed hand drawing exercises are received 115, the respondent's response to each exercise may be evaluated 120. In one embodiment, evaluating 120 each response may include providing a rating. Evaluating may include measuring a respondent's ability to do one or more of the reproducing of a symbol and filling in a symbol 121. A rating may be created by comparing a response by the respondent with a correct answer to each of the one or more exercises. Exercises may be evaluated by automatically rating the respondent's responses. In an embodiment, ratings may be determined based on the respondent's grade level.

Exercises may be rated using metrics. In one embodiment, metrics may include, but are not limited to, straightness, curvature, proportional sizing, proportional spacing, overall size, accurate tangencies, time to complete and/or uniformities.

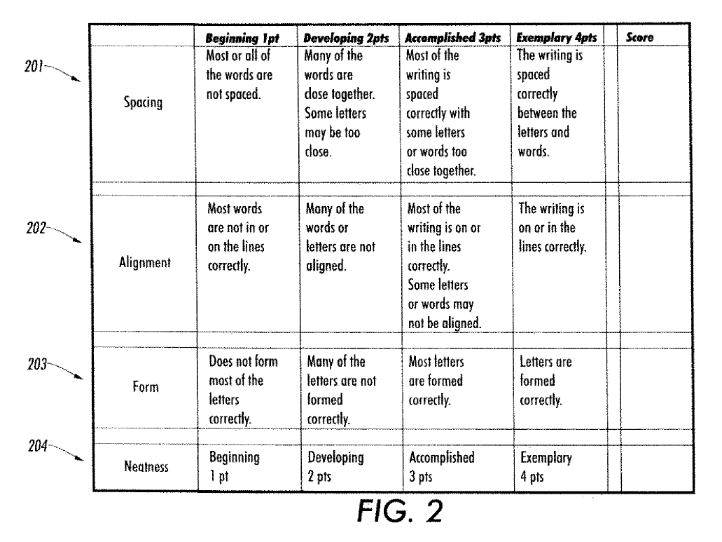

One or more metrics may be used to evaluate the respondent's response. In one embodiment, the metrics may be developed by prototyping the system with human evaluators providing a rubric based rating. The machine may then emulate the human evaluators by associating respondent reproductions with evaluator evaluations. In an alternate embodiment, the machine may emulate handwriting standards, such as, but not limited to the Minnesota Handwriting Assessment. FIG. 2 depicts an exemplary embodiment of a rubric for evaluating an exercise. The rubric depicted in FIG. 2 may evaluate the respondent on for example, four metrics: spacing 201, alignment 202, form 203 and neatness 204. More, fewer, alternate and/or additional metrics may also be used within the scope of this disclosure. The four metrics may be evaluated on a scale. For example, a value of “one” may represent a lowest rating and a value of “four” may represent a highest rating. The rubric may include a matrix of evaluations to be given for each metric based on the rating. For example, if the alignment metric 202 is given a rating of two, the evaluation provided may include a statement such as, “Many of the words or letters are not aligned.” In an embodiment, metrics may also include text size. In an embodiment, the scores may be automated.

Referring back to FIG. 1, the evaluation may also include annotations. In one embodiment, evaluating each response may include receiving an annotation that explains a respondent's deficiencies or proficiencies based on the respondent's response 122. In one embodiment; the annotations may be provided automatically as part of the evaluation process. The annotations may include the information determined by the matrix as discussed in FIG. 2. Alternately, an evaluator may provide annotations 123. In one embodiment, the evaluator may use a computing device to annotate the exercise, where the annotation may be either entered with a keyboard or electronic stylus. In another embodiment, the evaluator may provide annotations on a printed version of the respondent's work. The handwritten annotations provided by the evaluator may then be provided to that system via an optical-reader device. The annotations may illustrate areas where the respondent needs to improve or areas of strength for the respondent. For example, if an exercise requires a respondent to draw a circle and the respondent cannot draw a curved line, an annotation may address this deficiency in the respondent's response. In one embodiment, the annotations may be personalized based on the respondent's record. For example, if the respondent had previously spaced letters of a word too far apart, but in the current response has the letters the correct distance apart, the annotation may state “Your spacing has improved.” Similarly, if the respondent had received a score of 62 on a first assignment, a score of 88 on a second assignment and a score of 92 on a current assignment, the annotation may say “Keep up the good work!”

The respondent's record may be stored and updated 125. As discussed previously, the record may include respondent information, one or more responses, and one or more evaluations. Respondent information may include background and other information about the respondent. In addition to the name, age, grade, interests, and handedness of the respondent, the respondent information may also include skill level and one or more types of methodology preferred by the respondent. In one embodiment, a skill level and a preferred methodology for the respondent may be determined based on one or more evaluations of the respondent's responses. In one embodiment, a skill level may be determined for each methodology as well as an overall skill level created by averaging all the skill levels. Alternately, a skill level and a preferred methodology for the respondent may be determined by an evaluator. The evaluation of the respondent's responses to the hand drawing exercise may also be included in the record. In one embodiment, the record may store the respondent's rating on the exercise. In one embodiment, an image of the respondent's responses and/or one or more annotations may be stored in the record. In one embodiment the system may automatically generate the annotations based on stored respondent responses for a respondent at a time when the record is accessed.

The record may track the responses to the hand drawing exercises of the respondent. After the record is updated, an evaluation may be created 130. In one embodiment, in order to have an evaluation, there must be enough information in the record. If an evaluation is not given, more exercises may be completed 110. As a result of the record, one or more new hand drawing exercises may be selected based on the evaluations of the respondent's previous exercises. In one embodiment, the exercises may be based on a respondent's skill level. In one embodiment, a hand drawing exercise with a higher skill level may be selected if the respondent's rating equals or exceeds a threshold rating. In one embodiment, hand drawing exercises with a similar or lower skill level may be selected if the rating is less than a threshold rating. In one embodiment, the threshold rating may be predetermined. In another embodiment, the threshold rating may be determined by an evaluator. In an embodiment, the threshold rating may be determined by comparing the respondent to other similar respondents.

In an embodiment, one or more exercises may be selected based on the associated methodology. In one embodiment, hand drawing exercises with a different methodology may be selected based on the ratings. In one embodiment, if the respondent has a high rating in exercises having a particular methodology, exercises having that methodology may be provided to the respondent at a higher skill level. In another embodiment, the skill level and the methodology may be combined to determine the exercises to select for the respondent. In one embodiment, if the respondent has completed hand drawing exercises of a particular skill level and methodology, hand drawing exercises using a different methodology may be selected for the respondent.

If an evaluation is provided 130, then a respondent's record may be used to provide feedback to the respondent. Information may be provided based on the evaluated responses 135. For example, the record may examine old exercises completed by the respondent to determine when the respondent has improved in a particular task. If the respondent has not improved or has received a low rating on an exercise, the exercise may be reselected for the respondent. Alternatively, or in addition, similar exercises may be selected for a respondent who received a poor evaluation.

Additionally, the respondent may be evaluated to determine if the respondent has a disability 140. In one embodiment, evaluating the respondent's record may indicate that the respondent should be screened for possible disabilities. For example, a record with poor evaluations may be indicative of a motor neural disorder, motor memory deficiency, binocular-teaming disorder, dyslexia and/or other brain disorders.

In one embodiment, the system may be used to track the day-to-day progress of a student's hand drawing skills. For example, a student record may indicate that the student is an 8 year old male, who is right handed, and enjoys playing with toy automobiles. The system may create personalized exercises for the student which include the skills of drawing circles and squares in the shape of a car. This exercise may be printed for the student. The student may then complete the hand drawing exercise. After the completed exercise is received by the system, the exercise may be evaluated. The evaluation may state “Much improved!” based on comparing the student's drawing of a car to a previously submitted drawing of a truck. The record for the student may be updated based on the car drawing exercise. The student may then decide to attempt another exercise. When the student is finished, an evaluation may be provided to the student. The student's progress will be stored in the record so that if the student later requests another exercise, such exercise may be created based on the student's previous performance.

In an alternative embodiment, the system may be used to determine the performance of and to create exercises for a school, a school district, and/or a state. Each student may be given a set of exercises to complete. The completed exercises may be provided to the system, which may annotate the exercises. The record for each student may be updated based on the student's responses to the exercises. An evaluation may be provided which compiles and/or summarizes evaluations for all students in the school, district or state.

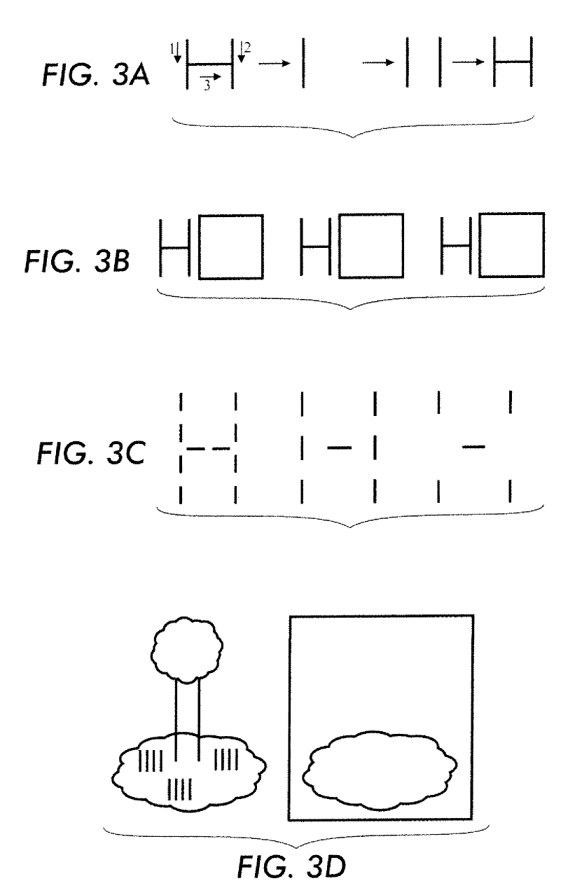

FIGS. 3A-D depict exemplary hand drawing exercises according to embodiments. FIG. 3A depicts teaching a child an order for drawing the letter “H.” The hand drawing exercise may be designed to teach a respondent each line that is necessary to create a letter. The exercise may teach an order in which the lines should be drawn so that a respondent may create the letter shown.

FIG. 3B depicts a letter “H” with an area besides it where the respondent may practice drawing the letter “H.” The letter may be drawn, for example, on a worksheet and scanned into the system.

FIG. 3C depicts an exercise where a respondent may draw the letter “H” by following a dotted outline. The exercises allow a respondent to practice hand drawing the letter “H.”

FIG. 3D depicts a more advanced exercise with a variety of symbols. Respondent may use their hand drawing skills to reproduce the illustration of an island with grass and trees.

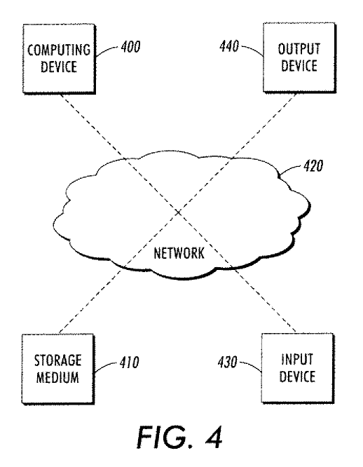

FIG. 4 depicts an exemplary system for evaluating a respondent's hand drawings according to an embodiment. The system includes a computing device 400 and a storage medium 410. The computing device 400 may be any type of computing device such as, for example, a server, a personal computer, a personal digital assistant, a web-enabled phone, a gaming system, a smart terminal or a dumb terminal and/or any other electronic device capable of communicating in a networked environment.

A storage medium 410 may be any repository of searchable data, such as a computer-readable memory database, table or other medium. The storage medium may communicate with a computing device 400 via a network 420 such as a local area network (LAN), wide area network (WAN), Internet or another communications network. Alternatively, the storage medium 410 may be contained within the computing device 400. In one embodiment, the system may include an input device 430.

An input device 430 is an electronic device that is capable of receiving commands and reading data into a computing device 400. An input device 430 may include, but is not limited to, a mouse, a touch screen, a tablet, an optical-reader device, a scanner, and/or a keyboard. In one embodiment, the system may include an output device 440.

An output device 440 is an electronic device that is capable of receiving commands and printing text and/or images on a substrate. An output device 440 may include, but is not limited to, a printer, a copier, a fax, a scanner and/or other device using ink or toner.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of performing hand drawing analysis, the method comprising:
storing a plurality of hand drawing exercises, wherein each hand drawing exercise is configured to test an ability to draw a symbol;
storing a record, wherein the record comprises respondent information;
selecting one or more hand drawing exercises;
receiving, via an optical-reader device, a response for each selected hand drawing exercise;
evaluating each response;
updating the record based on the evaluated responses; and
providing information based on the evaluated responses.

2. The method of claim 1 wherein selecting one or more hand drawing exercises comprises:
selecting one or more hand drawing exercises based on the record.

3. The method of claim 1 wherein selecting one or more hand drawing exercises comprises:
personalizing the one or more hand drawing exercises based on interests stored in the record.

4. The method of claim 1 wherein evaluating each response comprises:
measuring an ability to do one or more of reproducing a symbol and filling in a symbol.

5. The method of claim 1 wherein evaluating each response comprises:
for each response, determining a rating for the response by comparing the response with a correct answer for the hand drawing exercise.

6. The method of claim 5 wherein the rating is based on at least a grade level of a respondent.

7. The method of claim 1 wherein evaluating each response comprises:
automatically generating an annotation describing one or more deficiencies of the response.

8. The method of claim 1 wherein evaluating each response comprises:
generating personalized annotations based on the record.

9. The method of claim 1 wherein evaluating each response comprises:
automatically generating an annotation describing one or more strengths of the response.

10. The method of claim 1 wherein evaluating each response comprises:
receiving an annotation generated by an evaluator.

11. The method of claim 1 wherein storing a record comprises:
storing an image in the record.

12. The method of claim 1, further comprising:
determining if a respondent has a disability based on the record.

13. A method of hand drawing analysis, the method comprising:
storing a plurality of hand drawing exercises, wherein each hand drawing exercise tests an ability to draw a symbol, and wherein each hand drawing exercise comprises a skill level and a methodology;
selecting one or more hand drawing exercises;
receiving, via an optical-reader device, a response to each selected hand drawing exercise;
evaluating each response by creating a rating;
storing a record, wherein the record comprises respondent information and the rating; and
providing information based on the rating.

14. The method of claim 13 wherein selecting one or more hand drawing exercises comprises:
selecting hand drawing exercises having a higher skill level than a previous exercise if the rating equals or exceeds a threshold rating.

15. The method of claim 13 wherein selecting one or more hand drawing exercises comprises:
selecting hand drawing exercises having a lower skill level than a previous exercise if the rating is less than a threshold rating.

16. The method of claim 13 wherein selecting one or more hand drawing exercises comprises:
selecting hand drawing exercises having a different methodology than a previous exercise if the rating is less than a threshold rating.

17. The method of claim 13 wherein selecting one or more hand drawing exercises comprises:
selecting hand drawing exercises comprising a different methodology than a previous exercise if all exercises for the methodology were previously selected.

18. A method of performing hand drawing analysis, the method comprising:
storing a plurality of hand drawing exercises, wherein each hand drawing exercise is configured to test an ability to draw a symbol;
storing a record, wherein the record comprises respondent information;
selecting one or more personalized hand drawing exercises based on interests stored in the record;
receiving a response for each selected hand drawing exercise;
evaluating each response;
updating the record based on the evaluated responses; and
providing information based on the evaluated responses.

19. A system comprising:
a storage medium containing a plurality of hand drawing exercises, wherein each hand drawing exercise is configured to test an ability to draw a symbol, and wherein each hand drawing exercise comprises a skill level and a methodology;
a computing device in communication with the storage medium wherein the computing device is configured to select one or more hand drawing exercises; and
an optical-reader device in communication with the computing device, wherein the optical-reader device is configured to receive a response to each selected hand drawing exercise.

20. The system of claim 19, further comprising:
wherein the storage medium further contains a record comprising respondent information and a first rating, and
wherein the computing device is further configured to evaluate each response by creating a second rating and to store the second rating in the record.
